(19) United States
(12) Patent Application Publication
(10) Pub. No.: US 2023/0196247 A1
(43) Pub. Date: Jun. 22, 2023

(54) COMMUNICATION APPARATUS, COMMUNICATION METHOD, AND PROGRAM

(71) Applicants: KABUSHIKI KAISHA TOSHIBA, Tokyo (JP); Toshiba Digital Solutions Corporation, Kawasaki-shi (JP)

(72) Inventors: Masaru SUZUKI, Kanagawa (JP); Noriaki KOYAMA, Tokyo (JP); Go FUJINO, Tokyo (JP); Yoshimasa NIRASAWA, Chiba (JP); Yoshikata TOBITA, Tokyo (JP); Hidekazu MIYAKE, Tokyo (JP); Satoshi SONOH, Kanagawa (JP); Kentaro FURIHATA, Kanagawa (JP)

(73) Assignees: KABUSHIKI KAISHA TOSHIBA, Tokyo (JP); Toshiba Digital Solutions Corporation, Kawasaki-shi (JP)

(21) Appl. No.: 18/168,206

(22) Filed: Feb. 13, 2023

Related U.S. Application Data
(63) Continuation of application No. PCT/JP2021/029659, filed on Aug. 11, 2021.

(30) Foreign Application Priority Data
Aug. 26, 2020 (JP) 2020-142578

(51) Int. Cl. G06Q 10/0637; G06Q 10/067

(52) U.S. Cl. CPC G06Q 10/0637; G06Q 10/067

(57) ABSTRACT

A communication apparatus includes a business data storage unit which stores business data representative of a conducting history; an attribute imparting unit which generates attribute data representative of a conducting condition of the business in the first company; an attribute data storage unit which stores the attribute data corresponding to the first company; an attribute data disclosing unit which discloses the attribute data to a second company; an improvement proposal input unit which inputs therein information relating to an improvement proposal of the business for the first company; an improvement proposal disclosing unit which discloses the information relating to the improvement proposal to the first company; an improvement proposal acceptance receiver which receives a response of acceptance of the improvement proposal from the first company; and a proposal target disclosing unit which discloses information relating to the first company to the second company.

### CROSS REFERENCE TO RELATED APPLICATIONS

This application is a Continuation Application of PCT Application No.PCT/JP2021/029659, filed Aug. 11, 2021 and based upon and claiming the benefit of priority from prior Japanese Patent Application NO.2020-142578, filed Aug. 26, 2020, the entire contents of all of which are incorporated herein by reference.

### FIELD

Embodiments described herein relate generally to a communication apparatus, a communication method, and a program.

### BACKGROUND

Various problems in business are included in communication data in a company, and there is a case where a business improvement of the company can be implemented by analyzing the communication data. In addition, analysis means therefor has been proposed. For example, analysis means is conceivable which obtains information relating to an analysis target and information indicative of the state of the analysis target, constructs a knowledge database for acquiring knowledge corresponding to the state of the analysis target, and presents the knowledge corresponding to the state of the analysis target, based on the knowledge database.

However, since various expertise in the business field is necessary for making a proper analysis, it is difficult to make the analysis by the company itself. Thus, a company that wishes to improve its own business considers asking a consultant company or the like, which has expertise about the business field of the company, for an improvement proposal of the business, but it is difficult to select a consultant company that can present an appropriate improvement proposal. On the other hand, even if a consultant company, which wishes to obtain a compensation for the improvement of business of other companies, has expertise of a specific business field in which the consultant company is strong, it is difficult for the consultant company to select a company that conducts the specific business and to receive a request for a business improvement.

The problem to be solved by the present invention is to provide a communication apparatus, a communication method and a program, which can easily make matching between a company that wishes to improve business and a company that makes an analysis for improving the business.

### BRIEF DESCRIPTION OF THE DRAWINGS

FIG. 1 is a block diagram illustrating a configuration of a system in the present embodiment.

FIG. 2 is a block diagram illustrating a functional configuration for implementing a communication apparatus in the present embodiment.

FIG. 3 is a flowchart illustrating an operation of the communication apparatus in the present embodiment.

FIG. 4 is a view illustrating examples of communication log data, business attribute data and statistic data in the present embodiment.

FIG. 5 is a view illustrating examples of the communication log data, business attribute data and statistic data in the present embodiment.

FIG. 6 is a view illustrating an example of a screen for a consultant company, which is provided by a communication attribute data disclosing unit in the present embodiment.

FIG. 7 is a view illustrating an example of the screen for the consultant company, which is provided by the communication attribute data disclosing unit in the present embodiment.

FIG. 8 is a view illustrating an example of the screen for the consultant company, which is provided by the communication attribute data disclosing unit in the present embodiment.

FIG. 9 is a view illustrating an example of a screen for an improvement proposal input for a consultant company, which is provided by the communication attribute data disclosing unit in the present embodiment.

FIG. 10 is a view illustrating an example of a screen for analysis result browsing for a client company, which is provided by a communication attribute data analysis disclosing unit in the present embodiment.

FIG. 11 is a view illustrating an example of a screen for disclosing a summary of an improvement proposal for a client company, which is provided by an improvement proposal disclosing unit 32 in the present embodiment.

FIG. 12 is a view illustrating an example of a screen for receiving an advertisement registration from a consultant company in the present embodiment.

FIG. 13 is a view illustrating an example of a screen for analysis result browsing for a client company, which is provided by the communication attribute data analysis disclosing unit in the present embodiment.

### DETAILED DESCRIPTION

According to an embodiment, there is provided a communication apparatus which includes:
a business data storage unit configured to store business data representative of a conducting history of business, the business data being recorded in accordance with conducting of business in a first company;
an attribute imparting unit configured to generate, based on the business data, attribute data representative of a conducting condition of the business in the first company;
an attribute data storage unit configured to store the attribute data corresponding to the first company;
an attribute data disclosing unit configured to disclose the attribute data to a second company through a network;
an improvement proposal input unit configured to input therein, from the second company through the network, information relating to an improvement proposal of the business for the first company, which is based on the attribute data;
an improvement proposal disclosing unit configured to disclose the information relating to the improvement proposal, which is input from the second company, to the first company through the network;
an improvement proposal acceptance receiver configured to receive a response of acceptance of the improvement proposal from the first company; and
a proposal target disclosing unit configured to disclose information relating to the first company to the second company through the network, in accordance with the response of the acceptance of the improvement proposal.

Hereinafter, embodiments will be described with reference to the accompanying drawings.

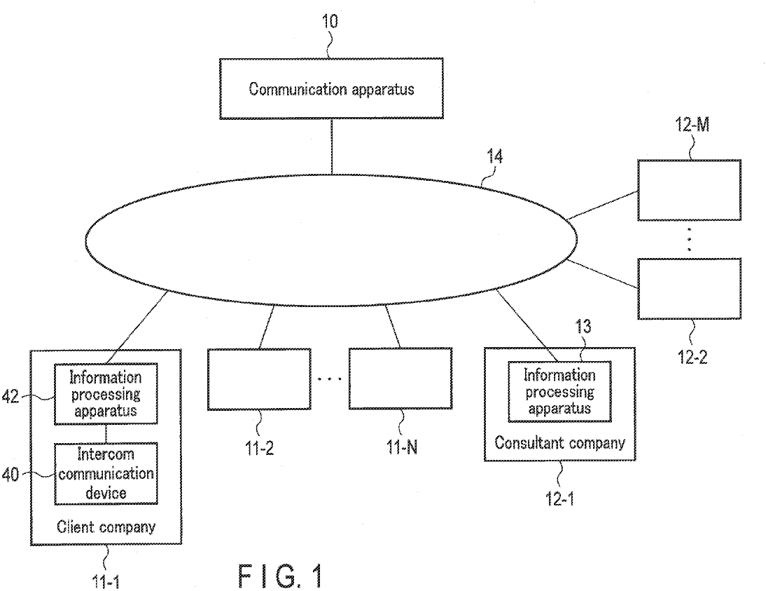

FIG. 1 is a block diagram illustrating a configuration of a system in the present embodiment. The system illustrated in FIG. 1 is a system for making matching between a company (client company) that wishes to improve business and a company (consultant company) that provides information for a business improvement by making an analysis for improving the business, via a communication data sharing platform that is provided by a communication apparatus 10 through a network 14.

As illustrated in FIG. 1, the communication apparatus 10 is connected to an information processing apparatus 42 provided in each of a plurality of client companies 11 (11-1, 11-2,..., 11-N) through the network 14 such as the internet. In addition, the communication apparatus 10 is connected to an information processing apparatus 13 provided in each of a plurality of consultant companies 12 (12-1, 12-2,..., 12-M) through the network 14. The information processing apparatus 42 of the client company 11 and the information processing apparatus 13 of the consultant company 12 can transmit and receive various data through the communication data sharing platform provided by the communication apparatus 10.

The communication apparatus 10 includes a function of providing the communication data sharing platform as a service through the network 14. The communication apparatus 10 is implemented by, for example, a computer (a server system or the like). The computer that implements the communication apparatus 10 includes a processor, a memory, a storage device, an input/output interface (I/F), a display device, an input device, a communication device, and the like.

The processor is circuitry for implementing various functions by executing a basic program (OS) and an application program stored in the memory. For example, the processor executes a program that provides a platform function as a service, thereby implementing a communication data sharing platform including functions to be described below.

Note that the communication apparatus 10 may be implemented by one computer (server), and may also be implemented by cloud computing in which a plurality of computers connected via the network 14 cooperate.

In order to make an analysis for a business improvement, the client company 11 records, in accordance with the conducting of business, for example, business data representative of a history relating to information transmitted and received between employees, and provides the business data to the communication apparatus 10 through the network 14. For example, the client company 11-1 is a shop of restaurant business, an accommodation facility (hotel) or the like, and records, as business data (communication log data), the history of data relating to a conversation between employees while business is being conducted, and provides the business data to the communication apparatus 10.

Note that the business data is not limited to the data relating to the conversation between employees. For example, the business data may be text data transmitted and received by chats (messages) utilizing emails, SNS (Social Networking Service) or the like, data relating to files that are transmitted and received, action record data such as meetings (including data of purposes of actions, participants, time, place and the like). In other words, the business data may be any data representative of the conducting condition of business that is operated in the client company 11.

The communication apparatus 10 creates, based on the business data (communication log data) provided from the information processing apparatus 42 of the client company 11, information (business attribute data representing the conducting state of business) that enables the consultant company 12 to present an improvement proposal of business, without disclosing business-related secrets, such as information of a name that can identify the client company 11, information relating to employees and information exchanged between employees, and discloses the created information to the consultant company 12.

In addition, the communication apparatus 10 makes matching between the consultant company 12 that inputs an improvement proposal for the client company 11, based on business attribute data, and the client company 11 that sends a response of acceptance of the improvement proposal, and discloses the client company 11 that is the target of the improvement proposal to the consultant company 12. Thereby, the client company 11 and the consultant company 12 can be introduced to each other through the communication apparatus 10 (communication data sharing platform).

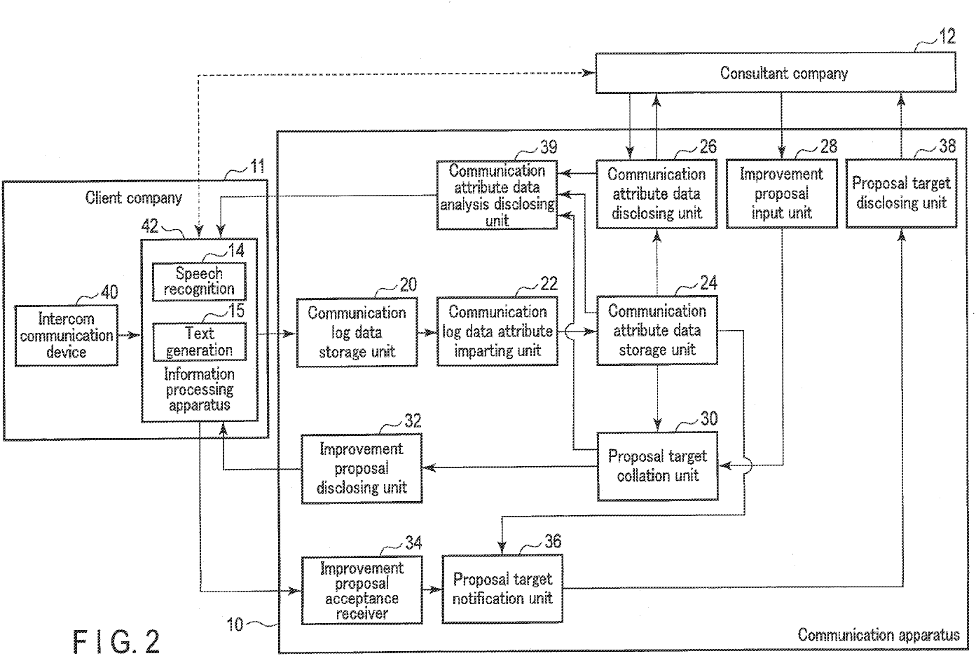

FIG. 2 is a block diagram illustrating a functional configuration for implementing the communication data sharing platform provided by the communication apparatus 10 in the present embodiment.

It is assumed that the client company 11 illustrated in FIG. 2 is, for example, an accommodation facility (hotel). A front desk clerk, an office clerk, cleaning staff and the like, who are employees, wear intercom communication devices 40, and exchange information by conversations via the intercom communication devices 40. The intercom communication device 40 is a kind of private telephone of a wireless intercommunication method, and is a business communication device including an earphone and a microphone. A scheme implemented by installing a purpose-specific application into a smartphone is included in the intercom communication device 40 that is defined here.

The information processing apparatus 42 is composed of a personal computer, a tablet computer or the like, and includes a function of communicating with an external device through the network 14, and a function of communicating with the intercom communication device 40. The information processing apparatus 42 includes a speech recognition unit 44 and a text generation processing unit 46. The speech recognition unit 44 receives speech data that is input from the intercom communication device 40 worn by each employee, and recognizes the speech by each employee. The text generation processing unit 46 executes speech recognition on the speech data of the speech recognized by the speech recognition unit 44, and converts the speech data to text data (hereinafter referred to as “speech content data”). The speech content data processed by the information processing apparatus 42 can be displayed on a display provided on the information processing apparatus 42, or on a display of a terminal device such as a tablet PC or a smartphone, or the intercom terminal 40, which is connected to the information processing apparatus 42 over a network.

The information processing apparatus 42 continuously records, as business data (communication log data), information including the speech content data relating to a conversation between the employees while business is being conducted. The information processing apparatus 42 provides the business data to the communication apparatus 10 (communication data sharing platform) in order to receive a business improvement from the client company 11.

The processor of the communication apparatus 10 implements functions illustrated in FIG. 2, by executing a program stored in the memory for implementing the communication data sharing platform. The functions implemented by the communication apparatus 10 include a communication log data storage unit 20, a communication log data attribute imparting unit 22, a communication attribute data storage unit 24, a communication attribute data disclosing unit 26, an improvement proposal input unit 28, a proposal target collation unit 30, an improvement proposal disclosing unit 32, an improvement proposal acceptance receiver 34, a proposal target notification unit 36, a proposal target disclosing unit 38, and a communication attribute data analysis disclosing unit 39.

The communication log data storage unit 20 receives, from the information processing apparatus 42 of the client company 11 via the network 14, business data (hereinafter, described as “communication log data”) that is recorded in accordance with the conducting of business in the client company 11, and stores the business data in a storage device or the like. In addition, the communication log data storage unit 20 receives and stores, along with the communication log data, data such as a business category, a scale, a location, a company name, an address and a contact address, which are basic information relating to the client company 11.

The communication log data attribute imparting unit 22 generates communication attribute data that is to be disclosed to the consultant company 12, based on the communication log data stored by the communication log data storage unit 20. The communication attribute data includes, for example, business attribute data representative of a conducting condition of business, and company attribute data indicative of a company attribute that is based on basic data relating to the client company 11.

The communication attribute data storage unit 24 correlates the business attribute data and company attribute data, which are generated by the communication log data attribute imparting unit 22, with unique information (company name, address, contact address, or the like) including an identifier of the client company 11, and stores the correlated data in a storage device or the like as the communication attribute data.

The communication attribute data disclosing unit 26 discloses, through the network 14, the communication attribute data stored by the communication attribute data storage unit 24, such that the consultant company 12 can make a business analysis. The communication attribute data disclosing unit 26 can input therein a narrow-down condition for narrowing down client companies 11 that are examination targets of improvement proposals from the consultant company 12, and can disclose to the consultant company 12 the communication attribute data corresponding to a plurality of client companies that meet the narrow-down condition. In addition, in accordance with an instruction from the consultant company 12, the communication attribute data disclosing unit 26 can register the narrow-down condition as an advertisement display condition for the communication apparatus 10 to display an advertisement in the information that is disclosed to the client companies 11.

The improvement proposal input unit 28 inputs therein a summary of an improvement proposal of business, which is input through the network 14 from the information processing apparatus 13 of the consultant company 12 that can present an improvement proposal of business to the client company 11, based on the communication attribute data disclosed by the communication attribute data disclosing unit 26.

The proposal target collation unit 30 executes collation as to which of the client companies 11 the summary of the improvement proposal of business, which is input by the improvement proposal input unit 28, corresponds to.

The improvement proposal disclosing unit 32 discloses, through the network 14, the summary of the improvement proposal, which is input by the consultant company 12, to the client company 11 collated by the proposal target collation unit 30.

The improvement proposal acceptance receiver 34 receives a response of acceptance of the improvement proposal from the client company 11 through the network 14, in a case where the client company 11 judges that the proposal is to be accepted, in regard to the summary of the improvement proposal disclosed by the improvement proposal disclosing unit 32.

The proposal target notification unit 36 notifies the proposal target disclosing unit 38 of the information of the client company 11 that is a proposal target of the improvement proposal, in accordance with the response of acceptance of the improvement proposal from the client company 11.

Upon receiving the notification from the proposal target notification unit 36, the proposal target disclosing unit 38 discloses the proposal target to the consultant company 12 that is a proposal source of the improvement proposal.

The communication attribute data analysis disclosing unit 39 discloses, in accordance with a request from the client company 11, the communication attribute data for the client company 11 that is the source of the request, to the client company 11 through the network 14. In addition, in a case where the client company 11 meets the narrow-down condition registered as the advertisement display condition by the consultant company 12, the communication attribute data analysis disclosing unit 39 discloses advertisement information (for example, an advertisement banner) of the consultant company 12 together with the communication attribute data.

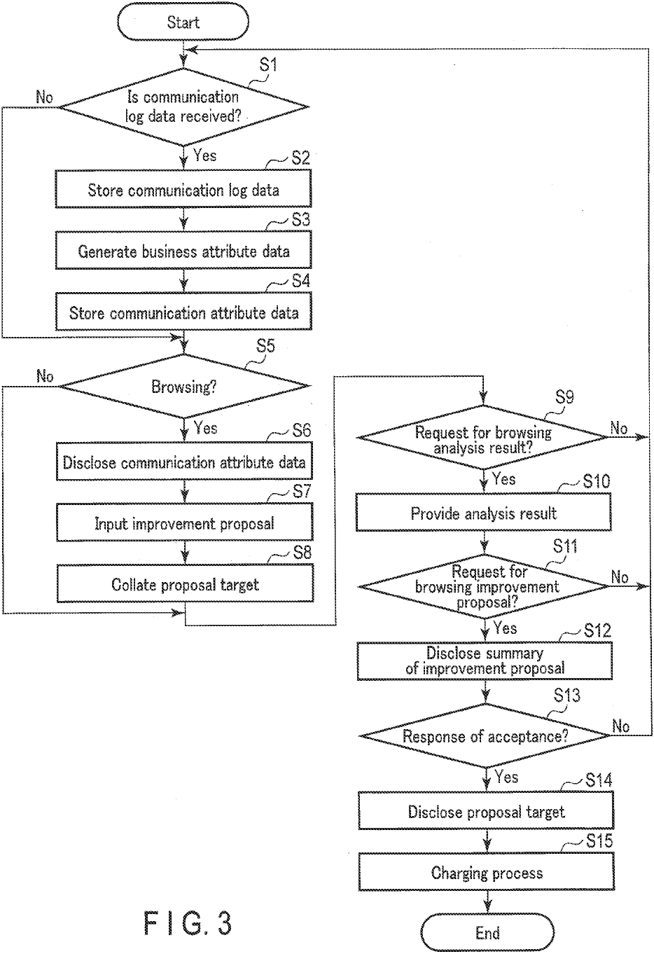

Next, an operation of the communication apparatus 10 in the present embodiment is described. FIG. 3 is a flowchart illustrating the operation of the communication apparatus 10.

For example, in a hotel that is the client company 11, employees, such as a front desk clerk, an office clerk and cleaning staff, wear the intercom communication devices 40, and exchange information by conversations via the intercom communication devices 40. Thereby, in the information processing apparatus 42, the history of data relating to the conversations during the conducting of business is recorded as the business data (communication log data). As regards the contents of the conversations, the speech data is speech-recognized by the text generation processing unit 46, and is thereby converted to text data (speech content data) and recorded.

In order to ask the consultant company 12 for an analysis for a business improvement, the client company 11 provides the business data (communication log data) recorded during the conducting of business to the communication data sharing platform.

The communication log data storage unit 20 receives the communication log data that is provided from information processing apparatus 42 (Yes in step S1 (to step S5 in the case of No)), and stores the communication log data in the storage device or the like (step S2). The communication log data storage unit 20 receives and stores the communication log data that is received from information processing apparatuses 42 of a plurality of client companies 11.

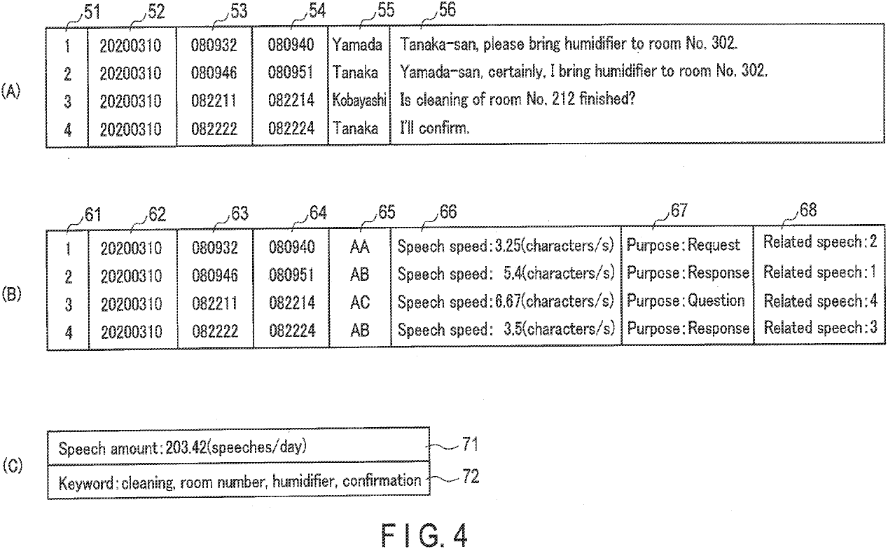

Part (A) of FIG. 4 is a view illustrating an example of communication log data that is provided from the information processing apparatus 42 of the client company 11 and is stored by the communication log data storage unit 20.

In the example of part (A) of FIG. 4, as the data (speech log data) relating to the conversations during the conducting of business, a speech number 51 added to each data of one speech is correlated with data indicative of a year/month/date 52 of the speech, a speech start time 53, a speech end time 54, a speaker name 55, and a speech content 56. The speech content 56 is the data converted to text by the text generation processing unit 46 of the information processing apparatus 42.

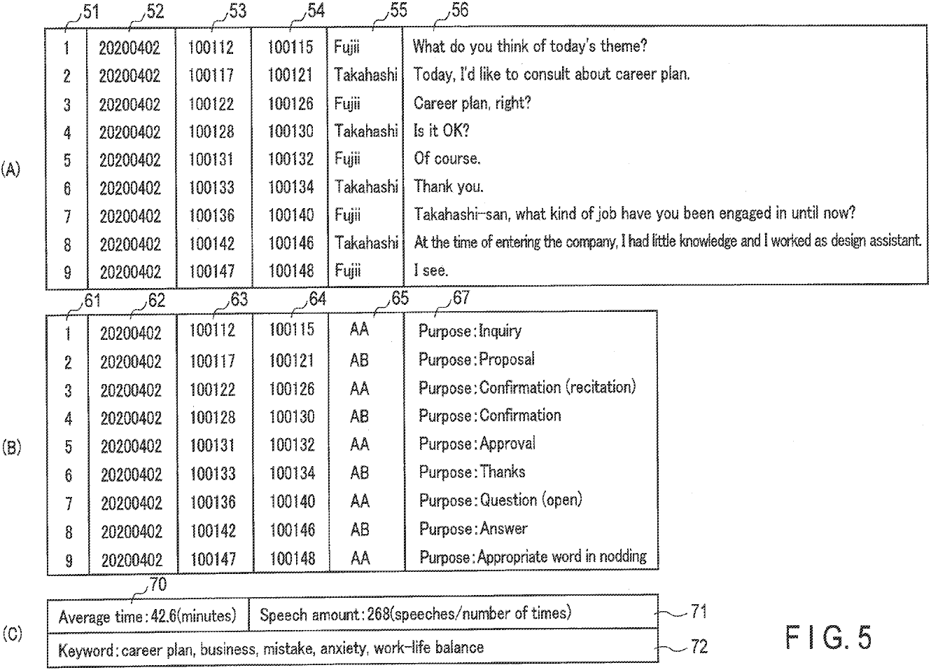

In addition, part (A) of FIG. 5 is a view illustrating an example of communication log data that is provided from the information processing apparatus 42 of another client company 11 and is stored by the communication log data storage unit 20. The communication log data illustrated in part (A) of FIG. 5 illustrates, for example, a part of data recorded in one meeting in the client company 11. As illustrated in part (A) of FIG. 5, although the same data as the communication log data illustrated in part (A) of FIG. 4 is included, since the business category is different, words (keywords) used in the conversation included in the speech content 56 are different.

Next, the communication log data attribute imparting unit 22 generates business attribute data representative of the conducting condition of business, based on the communication log data stored in the communication log data storage unit 20 (step S3). The communication log data attribute imparting unit 22 causes the communication attribute data storage unit 24 to store, as communication attribute data, the generated business attribute data, and business attribute data (for example, including a business category, a scale and a location) that is generated based on the basic information relating to the client company 11 (step S4).

It is assumed that the business attribute data in the present embodiment includes, for example, speech attribute data and statistic data. The speech attribute data is data that is added to each speech of employees recorded during the conducting of business, each speech being indicated by the communication log data. The statistic data is data that is computed based on a plurality of speeches (speech log data) indicated by the communication log data. The statistic data may be computed, for example, in regard to the whole of communication log data provided from one client company 11, or in regard to data corresponding to a predetermined period (the unit of a year, a month, a week, or the like), or data corresponding to employees in a specific range (a branch, a department, a floor, or the like) of the client company 11, or data classified under a specific condition (a gathering, a meeting, a time of dealing with customers, or the like).

Part (B) of FIG. 4 is a view illustrating an example of speech attribute data imparted to the communication log data illustrated in part (A) of FIG. 4.

In the example illustrated in part (B) of FIG. 4, a speech number 61, a year/month/date 62, a speech start time 63 and a speech end time 65, which correspond to the speech number 51, year/month/date 52, speech start time 53 and speech end time 54 of the communication log data, are correlated.

In addition, a speaker identifier 65, which corresponds to the speaker name 55, is associated. In the speaker identifier 65, unique identifier data, which is generated in regard to each speaker recorded as the speaker name 55, is set as the speaker identifier 65. For example, identifier data “AA” is generated for a speaker “Yamada” of a speaker number “1”. Thereby, information (here, the name) relating to a certain employee, which needs to be kept secret from the consultant company 12, is prevented from being disclosed.

In addition, in association with the speech number 61, a speech speed 66, a speech purpose 67 and a related speech 68, which are generated for each speech data, are correlated. The speech speed 66 indicates the number of read characters indicated in the speech content, for example, per one second from the speech start time 63 to the speech end time 65. The speech purpose 67 indicates a classification item indicative of the purpose of speech, which is determined by a sentence analysis of the text data of the speech content 56. Examples of the classification item of the purpose of speech include a request, a response, a question, an inquiry, a proposal, a confirmation, an approval, thanks, and an appropriate word in nodding. The related speech 68 indicates the speech number 61 of the other person of the speech (conversation), which is determined by a sentence analysis of the text data of the speech content 56.

For example, in association with the speech content 56 of the speech number “1”, “3.25 (characters/s)” in regard to the speech speed 66, “request” in regard to the speech purpose 67, and the speech number “2” in regard to the related speech 68 are correlated.

Part (C) of FIG. 4 is a view illustrating an example of statistic data that is imparted to the communication log data illustrated in part (A) of FIG. 4.

In the example illustrated in part (C) of FIG. 4, the statistic data includes data of a speech amount 71 and a keyword 72 with a high frequency of occurrence in the speech (conversation), which are based on the text data of all speeches included in the communication log data. For example, as regards the speech amount 71, the number of times of speech per day is indicated. In addition, as regards the keyword 72, it is assumed that the number of occurrences of each word in speeches of all employees is counted, and a word with the number of occurrences of a set value that is preset, or a plurality of words in higher ranks in regard to a preset number of occurrences, are extracted. Note that, instead of the number of occurrences of a word, the number of speeches including a word may be counted and a word may be extracted based on the number of speeches.

Part (B) of FIG. 5 is a view illustrating an example of speech attribute data imparted to the communication log data illustrated in part (A) of FIG. 5.

As illustrated in part (B) of FIG. 5, although similar data to the communication log data illustrated in part (A) of FIG. 5 is included, an example of the form in which the speech speed 66 and related speech 68 are omitted is illustrated.

Part (C) of FIG. 5 is a view illustrating an example of statistic data that is imparted to the communication log data illustrated in part (A) of FIG. 5. The statistic data illustrated in part (C) of FIG. 5 includes an average time 70 in addition to the speech amount 71 and the keyword 72. The communication log data illustrated in part (A) of FIG. 5 is, for example, data relating to, as an object, a conversation held in one meeting. In this case, the average time 70 indicates the time of the meeting. In addition, the speech amount 71 indicates not the number of times of speech per day illustrated in part (C) of FIG. 4, but the number of times of speech per one meeting (the number of times).

Based on the communication log data received from the plural client companies 11, the communication log data attribute imparting unit 22 generates the communication attribute data relating to each of the client companies 11, and causes the communication attribute data storage unit 24 to store the communication attribute data (steps S1 to S4).

If a screen (page) for browsing the information relating to the client companies 11 is accessed from the information processing apparatus 13 of the consultant company 12 through the network 14 (Yes in step S5 (to step S9 in the case of No)), the communication attribute data disclosing unit 26 provides the information processing apparatus 13 with a screen for disclosing the communication attribute data corresponding to the plural client companies 11, which is stored in the communication attribute data storage unit 24 (step S6).

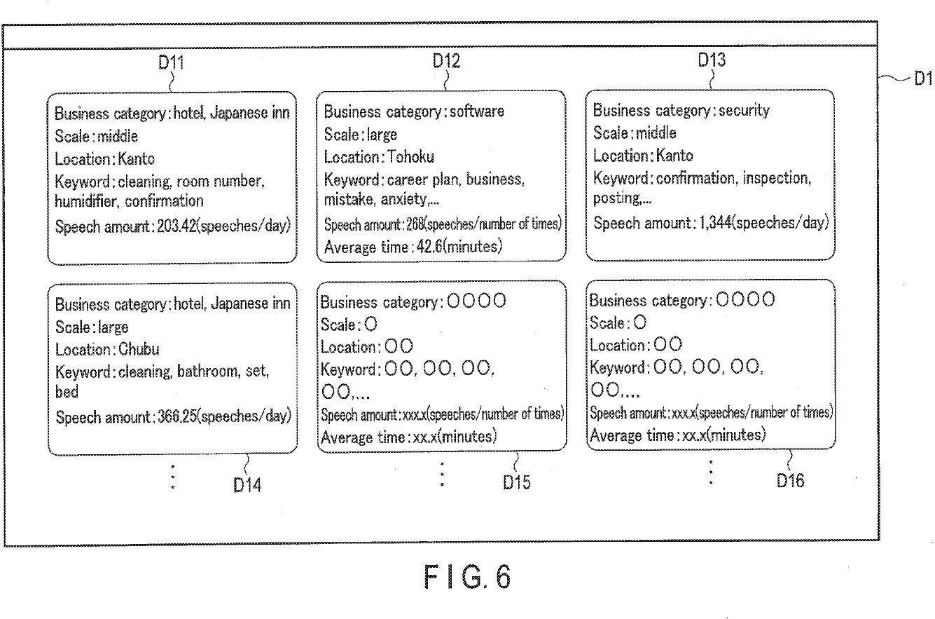

FIG. 6 is a view illustrating an example of a screen D1 for the consultant company, which is provided by the communication attribute data disclosing unit 26 in the present embodiment.

The screen D1 is provided with a table area that displays the communication attribute data corresponding to the plural client companies 11. The table area displays attribute display areas D11, D12, D13,..., which indicate the contents of the communication attribute data (company attribute data, business attribute data) in regard to the respective client companies 11.

For example, the attribute display area D11 displays the information of the business category “hotel, Japanese inn”, the scale “middle” and the location “Kanto”, which are based on the company attribute data, and the information of the keyword “cleaning, room number, humidifier, confirmation”, and the speech amount “203.42 (speeches/day)”, which are based on the statistic data of the business attribute data. Note that the information displayed in the attribute display areas D11, D12, D13,..., is not limited to the contents illustrated in FIG. 6.

In the information processing apparatus 13 of the consultant company 12, the screen D1 can be scrolled in accordance with a screen scroll operation, and the client company 11 that is a display target of the attribute display area can be changed. A person in charge in the consultant company 12 can select the client company 11 that is a business improvement proposal target, by referring to the information displayed on the attribute display area.

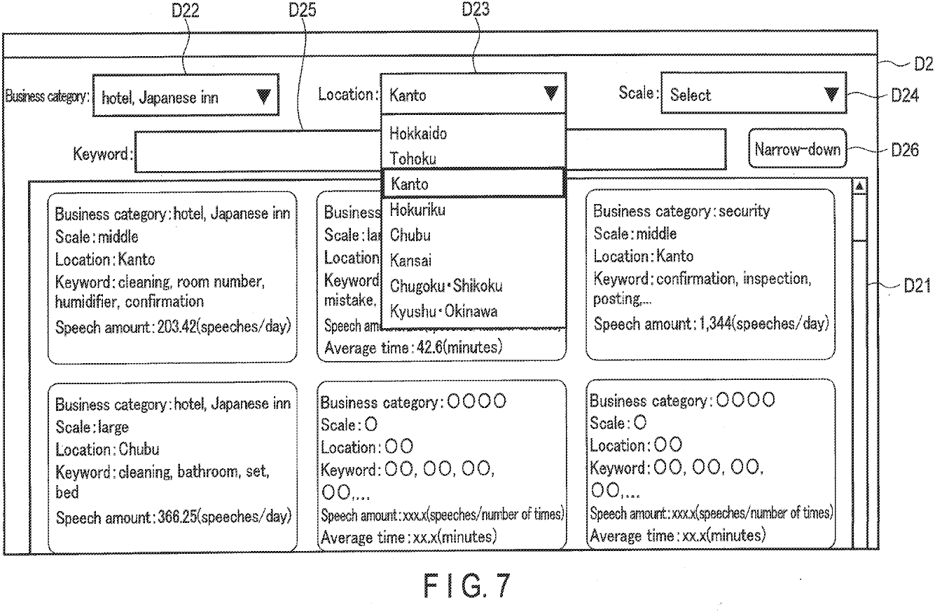

FIG. 7 is a view illustrating an example of a screen D2 for the consultant company, which is different from the screen D1 illustrated in FIG. 6, the screen D2 being provided by the communication attribute data disclosing unit 26 in the present embodiment. Note that which of the screen D1 and the screen D2 is to be displayed may be set in advance, or may be switched by an operation from the information processing apparatus 13.

The screen D2 is provided with a table area D21 that displays the communication attribute data corresponding to the respective client companies 11. The table area D21 displays attribute display areas that indicate the contents of the communication attribute data in regard to the respective client companies 11. Furthermore, the screen D2 is provided with a plurality of input areas for designating conditions for narrowing down the client companies 11 that are display targets of the attribute display areas, such that the client company 11 that is a business improvement proposal target can easily be selected from the plural client companies 11.

In the example illustrated in the screen D2, there are provided a business category input area D22, a location input area D23, a scale input area D24, a keyword input area D25, and a narrow-down execution button D26. Pull-down menus are prepared for the business category input area D22, location input area D23 and scale input area D24, and any one of choices can freely be selected from the table of data recorded as company attribute data in accordance with an operation of a bull-down button.

For example, in the screen D2 illustrated in FIG. 7, the pull-down menu for the location input area D23 is displayed, and a state in which “Kanto” is selected is illustrated.

In the keyword input area D25, one freely chosen text (word), or a plurality of freely chosen texts (words) (for example, AND condition), can be input. Note that a charge to the consultant company 12 can be made to occur by a keyword designated in the keyword input area D25. For example, the amount of the charge may be made different in accordance with the kind of keyword, the number of keywords, or the like.

Based on the conditions that are input in the input areas illustrated in the screen D2, the communication attribute data disclosing unit 26 searches the communication attribute data of the client companies 11 meeting the conditions from the communication attribute data storage unit 24. The communication attribute data disclosing unit 26 provides the information processing apparatus 13 with the screen D2 that displays the searched communication attribute data of the client companies 11 on the table area D21.

Thereby, a person in charge in the consultant company 12 can more efficiently select the client company 11 that is a business improvement proposal target, by referring to the information displayed on the attribute display areas, which is narrowed down under the conditions.

In a case where an operation of selecting any one of the attribute display areas (client companies 11) on the screen D1, D2, the communication attribute data disclosing unit 26 causes a screen D3 to be displayed on the information processing apparatus 13, the screen D3 disclosing the communication attributer data corresponding to the selected client company 11.

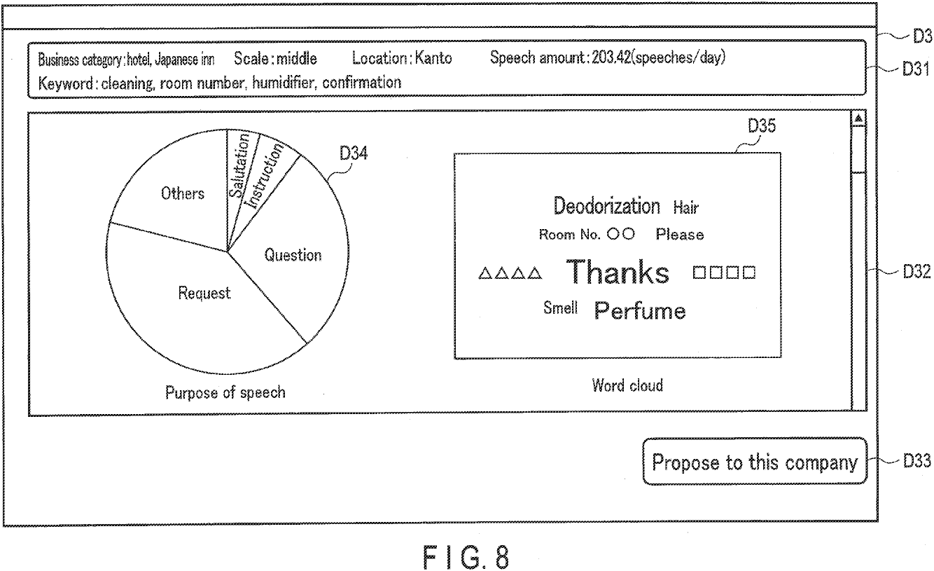

FIG. 8 is a view illustrating an example of the screen D3 for the consultant company, which is provided by the communication attribute data disclosing unit 26 in the present embodiment.

The screen D3 is provided with, for example, an attribute display area D31, an attribute image display area D32 and a proposal button D33.

The attribute display area D31 displays, by text, the contents of the communication attribute data (company attribute data, business attribute data) corresponding to the attribute display area (client company 11) selected on the screen D1, D2. The attribute image display area D32 displays attribute images in such forms as to enable intuitive recognition of the contents of the business attribute data (speech attribute data, statistic data).

For example, the attribute image display area D32 displays a speech purpose graph D34 and a word cloud D35. In the speech purpose graph D34, speech purposes of individual speeches included in all speech attribute data are counted in regard to each of classification items, and the ratio between the numbers of occurrences of classification items is expressed by, for example, a circle graph. Note that the speech purpose graph D34 is not limited to the circle graph, and may be a graph (for example, a bar graph) of some other form. The word cloud D35 displays each keyword by determining, in regard to each keyword included in the statistic data, the size and arrangement of characters (furthermore, the font, direction and character color) and the like, in accordance with the number of occurrences of each keyword in the communication log data. Basically, a keyword with a greater number of occurrences (for example, “thanks”) is displayed nearer to the center in a larger size. Thereby, the tendency of words (keywords) used in a conversation between the employees can easily be grasped intuitively.

Note that the attribute images displayed on the attribute image display area D32 are not limited to the above-described speech purpose graph D34 and word cloud D35, and may be displayed by other forms.

In accordance with an operation of the proposal button D33 on the screen D3, the communication attribute data disclosing unit 26 provides the information processing apparatus 13 with a screen D4 for inputting an improvement proposal.

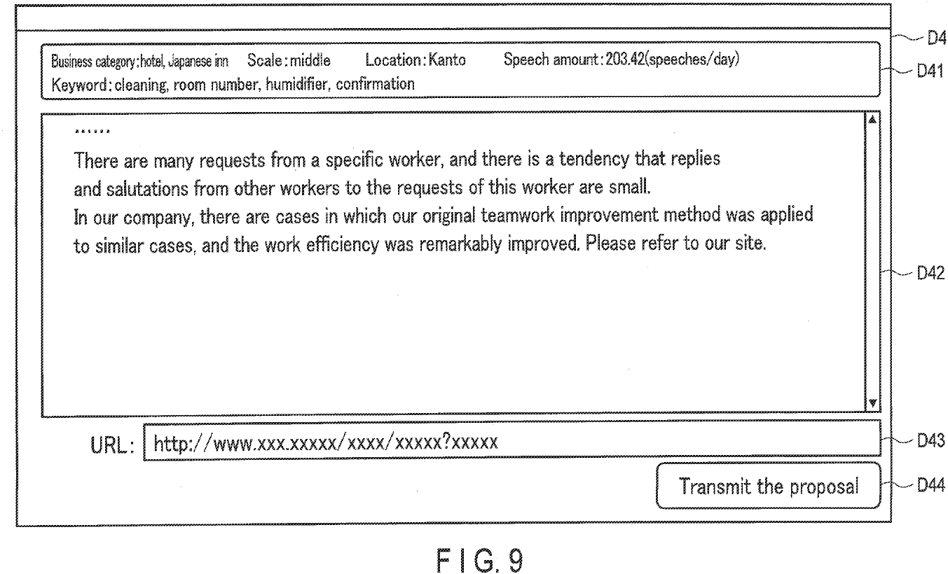

FIG. 9 is a view illustrating an example of the screen D4 for the consultant company, which is provided by the communication attribute data disclosing unit 26 in the present embodiment.

The screen D4 is provided with, for example, an attribute display area D41, an improvement proposal input area D42, a URL input area D43, and a proposal transmission button D44. FIG. 9 illustrates a state in which data has been input to the improvement proposal input area D42 and the URL input area D43, but the improvement proposal input area D42 and URL input area D43 are blank in the initial state.

The attribute display area D41 displays, by text, the contents of the same communication attribute data (company attribute data, business attribute data) as in the attribute display area D31 of the drawing D3. The improvement proposal input area D42 is an area for inputting/displaying text that is the contents (summary) of the improvement proposal, in accordance with an operation on the information processing apparatus 13 by a person in charge in the consultant company 12.

The URL input area D43 is an area for inputting/displaying a URL (uniform resource locator) of, for example, the company’s own site (home page) or the like, which the consultant company 12 publicizes through the network 14 (internet), in accordance with the operation of the person in charge in the consultant company 12 like the improvement proposal.

Note that on the screen D4, the URL input area D43 is provided and intended to prompt the client company 11 to access the company’s own site (home page), but other information for the client company 11 to contact the consultant company 12 may be input. For example, a contact address through SNS (Social Networking Service), an email address, an address, a telephone number, or the like may be input.

The person in charge in the consultant company 12 can select the client company 11 to which a business improvement proposal can be presented with expertise, based on the communication attribute data (company attribute data, business attribute data) of the client company 11, which is provided through the communication apparatus 10 (communication data sharing platform), and can input the contents of the business improvement proposal through the screen D4 that is provided by the communication data sharing platform.

If the proposal transmission button D44 is operated in the state in which an input is made to at least either the improvement proposal input area D42 or the URL input area D43, the improvement proposal input unit 28 inputs therein the data of the text indicative of the summary of the improvement proposal of the attribute display area D41 and the URL of the URL input area D43 (step S7).

If the data of the business improvement proposal is input by the improvement proposal input unit 28, the proposal target collation unit 30 collates which client company 11 the input data corresponds to (step S8). The communication attribute data disclosing unit 26 discloses the communication attribute data relating to a plurality of client companies 11 to a plurality of consultant companies 12. On the other hand, the consultant company 12 freely selects the client company 11 to which the business improvement proposal can be presented by using its own expertise. Thus, the proposal target collation unit 30 discriminates the correspondence between the client company 11 that is the source of the provision of the communication attribute data and the consultant company 12 that has selected this client company 11 and has input the business improvement proposal.

On the other hand, the client company 11 can access the communication apparatus 10 (communication data sharing platform) from the information processing apparatus 42, and can browse the analysis result by the communication apparatus 10 in regard to the communication log data that was provided in order to receive the business improvement proposal. Here, it is assumed that the analysis result by the communication apparatus 10 is, for example, the communication attribute data imparted by the communication data attribute imparting unit 22 in regard to the communication log data.

Upon receiving a browsing request for the analysis result from the information processing apparatus 42 of the client apparatus 11 (step S9, Yes), the communication attribute data analysis disclosing unit 39 provides a screen D5 for analysis result browsing to the information processing apparatus 42, and causes the screen D5 to be displayed (step S10).

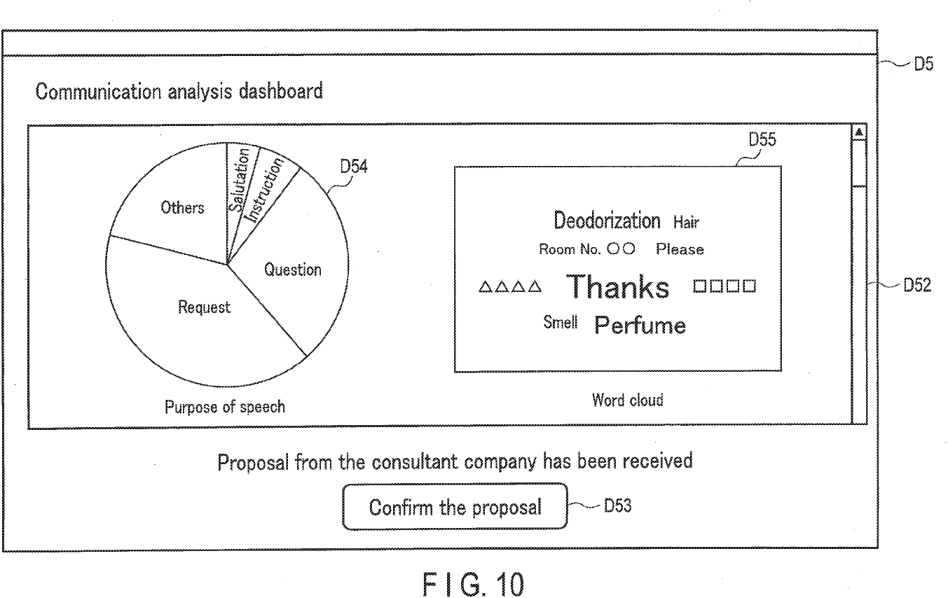

FIG. 10 is a view illustrating an example of the screen D5 (communication analysis dashboard) for analysis result browsing for the client company, which is provided by the communication attribute data analysis disclosing unit 39 in the present embodiment.

The screen D5 is provided with, for example, an attribute image display area D52.

The attribute image display area D52 displays attribute images in such forms as to enable intuitive recognition of the contents of the business attribute data (speech attribute data, statistic data) imparted to the communication log data that is provided by the client company 11. For example, the attribute image display area D52 displays a speech purpose graph D54 and a word cloud D55 in the same form as the above-described attribute image display area D32 of the screen D3 for the consultant company illustrated in FIG. 8. Note that the form of the attribute images representative of the content of the business attribute data may be different between the attribute images for the client company and the attribute images for the consultant company.

In addition, in a case where the business improvement proposal has already been input from the consultant company 12 to the client company 11 that requested the browsing of the analysis result, the communication attribute data analysis disclosing unit 39 causes the screen D5 to display a proposal confirmation button D53 and a message such as “Proposal from the consultant company has been received”, for example, as illustrated in FIG. 10. Thereby, in the client company 11, the presence/absence of a business improvement proposal from the consultant company 12 can be confirmed on the screen D5 for analysis result browsing.

If the proposal confirmation button D53 of the screen D5 is operated (step S11, Yes), the improvement proposal disclosing unit 32 provides the client company 11, which is collated by the proposal target collation unit 30, with a screen D6 for disclosing the summary of the improvement proposal that is input by the consultant company 12, and causes the screen D6 to be displayed (step S12) .

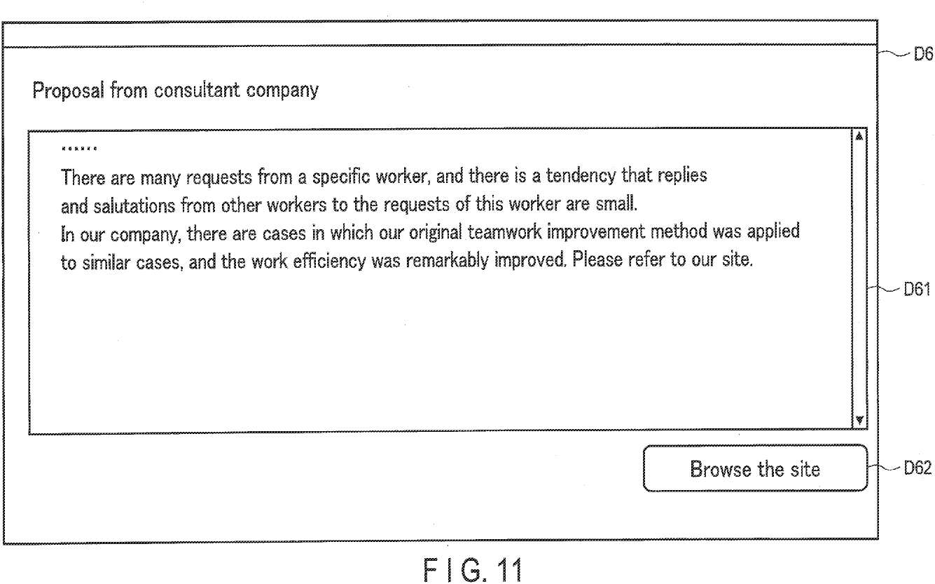

FIG. 11 is a view illustrating an example of the screen D6 for disclosing the summary of an improvement proposal for a client company, which is provided by the improvement proposal disclosing unit 32 in the present embodiment.

The screen D6 is provided with, for example, an improvement proposal display area D61 and a site browsing button D62.

The improvement proposal display area D61 is an area for displaying text that is the contents (summary) of the improvement proposal that is input to the client company 11 from the consultant company 12. The site browsing button D62 is a button for accepting, as a response, the improvement proposal from the consultant company 12. If the site browsing button D62 is operated, the information processing apparatus 42 is caused to access the site of the URL designated by the consultant company 12 that has input the improvement proposal.

If improvement proposals are input from a plurality of consultant companies 12 to one client company 11, the contents displayed on the improvement proposal display area D61 is switched to the contents of an improvement proposal that is input from the next consultant company 12, in accordance with an operation of the information processing apparatus 42.

Thereby, the client company 11 can confirm the summary of the improvement proposal that was presented by the consultant company 12. In addition, in the case where improvement proposals are input from the plural consultant companies 12, it is possible to select the consultant company 12 from which a more appropriate, detailed business improvement proposal for the own company can be expected.

If the site browsing button D62 of the screen D6 is operated, the improvement proposal acceptance receiver 34 receives the response of acceptance from the client company 11, assuming that the client company 11 accepted the proposal in regard to the summary of the improvement proposal disclosed by the improvement proposal disclosing unit 32 (step S13, Yes).

In accordance with the response of acceptance of the improvement proposal from the client company 11, the proposal target notification unit 36 acquires, from the communication attribute data storage unit 24, the unique information (company name, address, contract address and the like) of the client company 11 that is the proposal target of the improvement proposal, which made the response of acceptance, and notifies the unique information to the proposal target disclosing unit 38.

Upon receiving the notification from the proposal target notification unit 36, the proposal target disclosing unit 38 discloses the proposal target to the consultant company 12 that is the proposal source of the improvement proposal (step S14). By acquiring the information of the client company 11 that accepted the summary of the improvement proposal through the communication apparatus 10, the consultant company 12 can directly contact the client company 11 and can transition to business for presenting a more detailed business improvement proposal.

Note that, responding to the operation of the site browsing button D62 of the screen D6, the improvement proposal acceptance receiver 34 causes the information processing apparatus 42 to access the site of the URL designated by the consultant company 12 that has input the improvement proposal, and causes the information processing apparatus 42 to display the screen (Web page) of the site of the designated URL.

By guiding the client company 11 to the site designated by the consultant company 12, the communication apparatus 10 may charge the consultant company 12. For example, the improvement proposal acceptance receiver 34 executes a charging process in accordance with an operation (a click operation or the like) on the site browsing button D62, and records charging data that is individually managed for each of the consultant companies 12 (step S15). For example, the communication apparatus 10 successively adds an amount, which is determined in advance for one operation (click operation) on the site browsing button D62, to the charging data corresponding to the consultant company 12. An operator of the communication apparatus 10 can charge each consultant company 12 for a fee based on charging data at a predetermined timing, and can obtain a reward.

Note that aside from charging in accordance with the operation (click operation or the like) on the site browsing button D62, it is possible to use other charging conditions, such as charging in accordance with browsing of advertisement (displaying on the information processing apparatus 42).

In addition, the communication apparatus 10 may assume that matching is made between the client company 11 and the consultant company 12 by the response of acceptance of the improvement proposal by the client company 11, and may charge the client company 11 and the consultant company 12 for a fee as a reward for contract completion. In the same manner as described above, the communication apparatus 10 individually manages the charging data relating to the reward for contract completion for each of the client company 11 and the consultant company 12. Thereby, the operator of the communication apparatus 10 can charge each of the client company 11 and the consultant company 12 for a fee based on charging data of the reward for contract completion, and can obtain the reward.

In the above description, the example is illustrated in which a charge is made for the guiding to the site designated by the consultant company 12 and a charge is made as the reward for contract completion for the matching between the client company 11 and the consultant company 12, but other charges can be made.

For example, a charge can be made to occur by providing the client company 11 with an advertisement that the consultant company 12 registered.

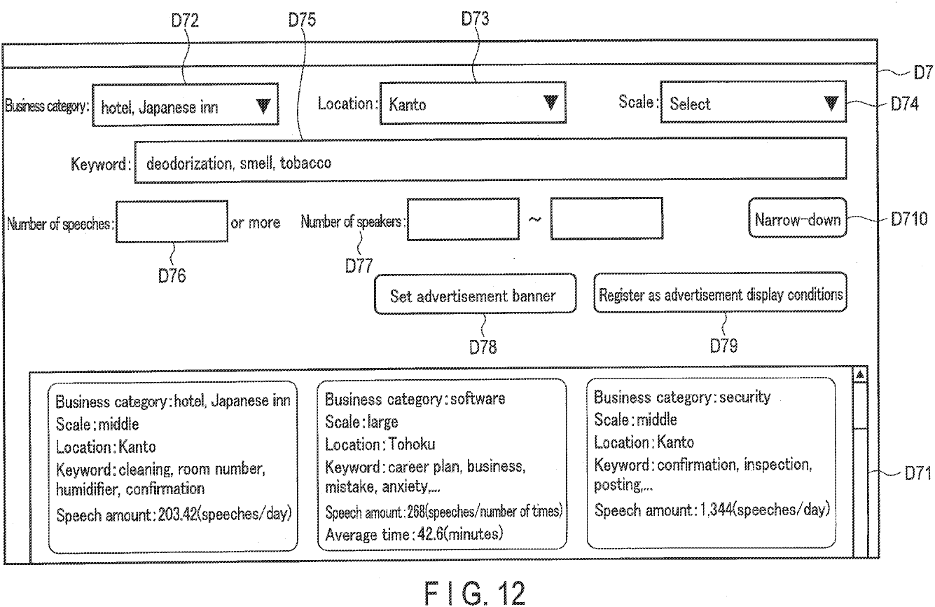

FIG. 12 is a view illustrating an example of a screen D7 for receiving an advertisement registration from the consultant company 12 in the present embodiment. The screen D7 illustrated in FIG. 12 is an applied screen example of the screen D2 for the consultant company illustrated in FIG. 7. For example, the communication attribute data disclosing unit 26 receives an advertisement registration through the screen D7 by displaying the screen D7 in place of the screen D2.

A table area D71, a business category input area D72, a location input area D73, a scale input area D74, a keyword input area D75 and a narrow-down execution button D710 of the screen D7 illustrated in FIG. 12 are assumed to be the same as the table area D21, business category input area D22, location input area D23, scale input area D24, keyword input area D25 and narrow-down execution button D26 of the screen D2 illustrated in FIG. 7, and a description thereof is omitted. The screen D7 is further provided with a number-of-speeches input area D76, a number-of-speakers input area D77, an advertisement content setting button D78 and an advertisement condition registration button D79. The areas D72 to D77 are areas for setting conditions (advertisement display conditions) for narrowing down the client companies 11 that are targets of provision of advertisement (advertisement banner) registered by the consultant company 12.

The number-of-speeches input area D76 is an area for designating the number of speeches (speech log data) between employees included in the communication log data provided from the client company 11. The number-of-speakers input area D77 is an area for designating the number of speakers which are similarly included in the communication log data. It is assumed that the number-of-speakers input area D77 illustrated in FIG. 12 can designate the range of the number of speakers (between oo and oo).

If the advertisement content setting button D78 is operated, the communication attribute data disclosing unit 26 enters a reception state of information (here, advertisement banner) of advertisement that is provided to the client company 11, inputs therein the information (advertisement banner) of advertisement designated by the consultant company 12 (information processing apparatus 13), and provides the information to the communication attribute data analysis disclosing unit 39.

In addition, if the advertisement condition registration button D79 is operated, the communication attribute data disclosing unit 26 inputs therein the contents, which are input to the areas D72 to D77, as the advertisement display conditions, and provides the input contents to the communication attribute data analysis disclosing unit 39.

The communication attribute data analysis disclosing unit 39 stores the advertisement information (advertisement banner) and the advertisement display conditions by correlating them with the client company 11. By registering the advertisement display conditions, advertisement can be provided restrictively to the client company 11 with a high advertisement effect.

Upon receiving a browsing request for an analysis result from the information processing apparatus 42 of the client company 11, the communication attribute data analysis disclosing unit 39 determines whether the client company 11 meets the advertisement display conditions registered by the consultant company 12. If it is determined that the client company 11 meets the advertisement display conditions, the communication attribute data analysis disclosing unit 39 provides the information processing apparatus 42 with a screen D8 for analysis result browsing, on which the advertisement registered by the relevant consultant company 12 is posted, and causes the screen D8 to be displayed.

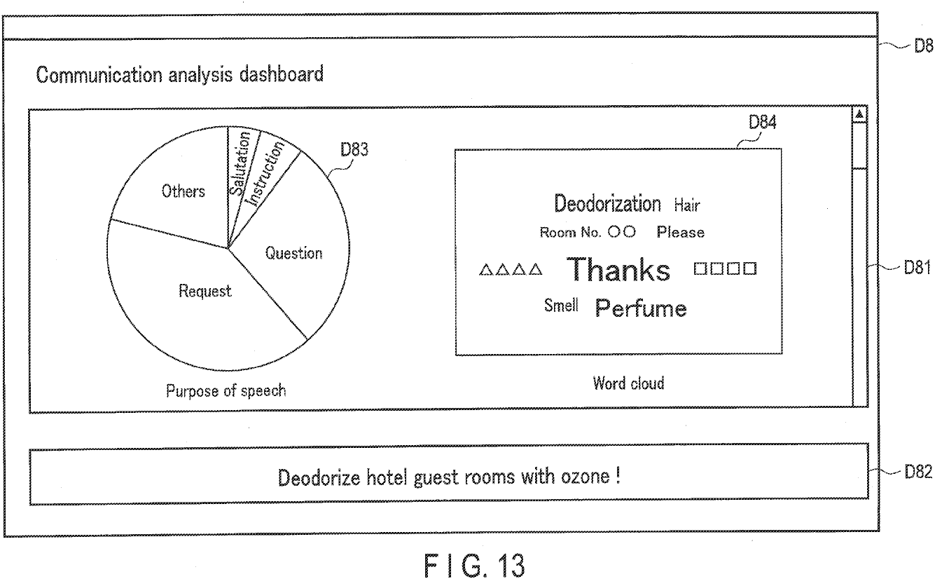

FIG. 13 is a view illustrating an example of the screen D8 (communication analysis dashboard) for analysis result browsing for the client company, which is provided by the communication attribute data analysis disclosing unit 39 in the present embodiment.

The screen D8 is provided with, for example, an attribute image display area D81 and an advertisement display area D82.

Assuming that the attribute image display area D81 is the same as the attribute image display area D52 of the screen D5 illustrated in FIG. 10, a description thereof is omitted. The advertisement display area D82 displays the advertisement contents (advertisement banner) registered by the consultant company 12. Thus, the advertisement registered by the consultant company 12 can be provided to the client company 11 that meets the advertisement display conditions.

Note that, like the screen D5 illustrated in FIG. 10, the screen D8 may be configured to display the proposal confirmation button in a case where the business improvement proposal has already been input from the consultant company 12.

Responding to a selection operation of the advertisement display area D82 (advertisement banner) of the screen D8, the communication attribute data analysis disclosing unit 39 causes the information processing apparatus 42 to access the site set on the advertisement banner, and causes the screen (Web page) of the site for advertisement to be displayed on the information processing apparatus 42.

Responding to an operation (click operation or the like) on the advertisement display area D82 (advertisement banner), the communication attribute data analysis disclosing unit 39 records charging data that is individually managed in regard to each consultant company 12. For example, the communication apparatus 10 successively adds an amount, which is determined in advance for one operation (click operation) on the advertisement display area D82, to the charging data corresponding to the consultant company 12. An operator of the communication apparatus 10 can charge each consultant company 12 for a fee based on charging data at a predetermined timing, and can obtain a reward.

In addition, aside from the charging in accordance with the operation on the advertisement display area D82 (advertisement banner), the communication attribute data analysis disclosing unit 39 may also charge in accordance with the advertisement display conditions input to the areas D72 to D77 of the screen D7 illustrated in FIG. 12, or in accordance with the advertisement contents set by the advertisement content setting button D78. For example, as regards the advertisement display conditions, a higher charge amount is set for a condition that a greater number of client companies 11 meet. In addition, as regards the advertisement contents, a charge amount is set in accordance with the number of characters, an image size, a display size and the like of the advertisement provided to the client company 11.

In this manner, the operator of the communication apparatus 10 (communication data sharing platform) can obtain a profit by providing services using the communication data sharing platform.

Thus, according to the communication apparatus 10 in the present embodiment, matching can easily be made between the client company 11 that wishes to improve business and the consultant company 12 that makes an analysis for improving the business, and an efficient business improvement can be implemented. In the communication apparatus 10 (communication data sharing platform), while the communication log data transmitted/received between employees in the client company 11 is analyzed and the business attribute data representative of the conducting condition of business is imparted, the original communication log data itself is not disclosed and business-related secrets or the like are kept unknown, and the attribute data can be shared with the external consultant company 12 having expertise. By keeping unknown the business-related secrets or the like, since business improvement proposals can be received from many consultant companies, it can be expected that the consultant company 12 that can propose an appropriate business improvement can be selected more easily.

The consultant company 12 analyzes the communication attribute data that is imparted based on the communication log data, and, if a possibility of a business improvement in regard to a tendency in communication, wastefulness or the like is obtained, the consultant company 12 presents an improvement proposal to the client company 11 through the communication apparatus 10. Since the communication attribute data relating to many client companies 11 is presented to the consultant company 12 through the communication apparatus 10, the consultant company 12 can select the client company 11 for which its own expertise can effectively be utilized, and can present an appropriate improvement proposal. The client company 11 can determine whether or not to accept the improvement proposal from the consultant company 12. If the improvement proposal is accepted, the client company 11 and the consultant company 12 are mutually provided with information via the communication apparatus 10, and a more detailed business improvement proposed can be implemented.

Note that the method described in each of the above embodiments can be distributed as a computer-executable program, by being stored in a storage medium such as a magnetic disk (flexible disk, hard disk or the like), an optical disc (CD-ROM, DVD or the like), a magneto-optical disc (MO), or a semiconductor memory.

In addition, if the storage medium can store a program and can be read by a computer, the storage medium may be of any storage form.

Additionally, based on the instructions of the program installed in the computer from the storage medium, the OS (operating system) running on the computer, or database management software, or MW (middleware) of a network, or the like, may execute a part of each process for implementing the above embodiments.

Additionally, the storage medium in the embodiments is not limited to a medium that is independent from the computer, and may include a storage medium that downloads, and stores or temporarily stores, a program that is transmitted through a LAN, the internet, or the like.

Additionally, the number of storage media is not limited to one. Also when the process in the embodiments is executed from a plurality of storage media, such media are included in the storage medium in the invention, and the media may have any configuration.

Note that the computer in the embodiments executes the processes in the embodiments, based on the program stored in the storage medium, and may have any configuration, such as one apparatus composed of a personal computer or the like, or a system in which a plurality of apparatuses are connected via a network.

Additionally, the computer in the embodiments includes an arithmetic processing apparatus included in an information processing apparatus, a microcomputer, and the like, and is a generic term for devices and apparatuses which can implement the functions of the invention by programs.

While certain embodiments of the present invention have been described, these embodiments have been presented by way of example only, and are not intended to limit the scope of the invention. These novel embodiments may be implemented in a variety of other forms, and various omissions, substitutions and changes may be made without departing from the spirit of the inventions. These embodiments and their modifications fall within the scope and spirit of the invention and within the inventions of the accompanying claims and their equivalents.

What is claimed is:

1. A communication apparatus comprising:
a business data storage unit configured to store business data representative of a conducting history of business, the business data being recorded in accordance with conducting of business in a first company;
an attribute imparting unit configured to generate, based on the business data, attribute data representative of a conducting condition of the business in the first company;
an attribute data storage unit configured to store the attribute data corresponding to the first company;
an attribute data disclosing unit configured to disclose the attribute data to a second company through a network;
an improvement proposal input unit configured to input therein, from the second company through the network, information relating to an improvement proposal of the business for the first company, which is based on the attribute data;
an improvement proposal disclosing unit configured to disclose the information relating to the improvement proposal, which is input from the second company, to the first company through the network;
an improvement proposal acceptance receiver configured to receive a response of acceptance of the improvement proposal from the first company; and
a proposal target disclosing unit configured to disclose information relating to the first company to the second company through the network, in accordance with the response of the acceptance of the improvement proposal.

2. The communication apparatus of claim 1, wherein
the business data is data indicative of a content of information transmitted and received between employees while the business is being conducted in the first company, and
the attribute imparting unit generates the attribute data representative of the conducting condition of the business by the employees in the first company.

3. The communication apparatus of claim 1, wherein
the business data includes data relating to a conversation held between employees while the business is being conducted in the first company, and
the attribute imparting unit generates the attribute data representative of at least one of a keyword occurring in the conversation, a speech amount, and a speech purpose.

4. The communication apparatus of claim 1, wherein the attribute data disclosing unit discloses the attribute data corresponding to each of a plurality of the first companies to a plurality of the second companies.

5. The communication apparatus of claim 4, wherein the attribute data disclosing unit inputs therein a designation of a condition for disclosing the attribute data from the second company, and discloses the attribute data of the first company that meets the condition.

6. The communication apparatus of claim 1, further comprising an attribute data analysis disclosing unit configured to receive a setting of advertisement information from the second company, configured to disclose to the first company through the network the advertisement information together with a content of the attribute data, in accordance with a request for disclosure relating to the attribute data from the first company, and configured to generate charging, based on the disclosing of the advertisement information.

7. A communication method by a communication apparatus, comprising:
generating attribute data representative of a conducting condition of business in a first company, based on business data representative of a conducting history of the business, the business data being recorded in accordance with conducting of the business in the first company;
disclosing the attribute data corresponding to the first company to a second company through a network;
inputting, from the second company through the network, information relating to an improvement proposal of the business for the first company, which is based on the attribute data;
disclosing the information relating to the improvement proposal, which is input from the second company, to the first company through the network;
receiving a response of acceptance of the improvement proposal from the first company; and
disclosing information relating to the first company to the second company through the network, in accordance with the response of the acceptance of the improvement proposal.

8. A program for causing a computer to function as:
a business data storage unit configured to store business data representative of a conducting history of business, the business data being recorded in accordance with conducting of business in a first company;
an attribute imparting unit configured to generate, based on the business data, attribute data representative of a conducting condition of the business in the first company;
an attribute data storage unit configured to store the attribute data corresponding to the first company;
an attribute data disclosing unit configured to disclose the attribute data to a second company through a network;
an improvement proposal input unit configured to input therein, from the second company through the network, information relating to an improvement proposal of the business for the first company, which is based on the attribute data;
an improvement proposal disclosing unit configured to disclose the information relating to the improvement proposal, which is input from the second company, to the first company through the network;
an improvement proposal acceptance receiver configured to receive a response of acceptance of the improvement proposal from the first company; and
a proposal target disclosing unit configured to disclose information relating to the first company to the second company through the network, in accordance with the response of the acceptance of the improvement proposal.
